(19) United States
(12) Patent Application Publication
(10) Pub. No.: US 2023/0143343 A1
(43) Pub. Date: May 11, 2023

(54) METHOD AND SYSTEM FOR REGULAR TESTING OF DATACENTER HARDWARE

(71) Applicant: FLIPKART INTERNET PRIVATE LIMITED, Bengaluru (IN)

(72) Inventor: Rupinder Singh Khokhar, Delhi (IN)

(73) Assignee: FLIPKART INTERNET PRIVATE LIMITED, Bengaluru (IN)

(21) Appl. No.: 17/980,783

(22) Filed: Nov. 4, 2022

(30) Foreign Application Priority Data
Nov. 9, 2021 (IN) 202141051193

(51) Int. Cl. G06F 11/20; G06F 11/30; G06F 11/34

(52) U.S. Cl. CPC G06F 11/2041; G06F 11/3006; G06F 11/3423

(57) ABSTRACT

The present disclosure relates to a method and system for controlling output characteristics of a media streaming over a media output device. The system [100] comprises a processing unit [102] and a testing unit [104] coupled with the processing unit [102]. The processing unit [102] identifies one or more unused hardware servers from the datacenter hardware, and then selects a first set of unused hardware servers for testing, from the identified one or more unused hardware servers. Further, the testing unit [104] performs one or more tests on the selected first set of unused hardware servers, wherein each unused hardware server from the selected first set of unused hardware servers is in operational state. The system [100] further repeats the steps to perform testing on a second set of unused hardware servers, a third set of unused hardware servers, and so on.

### RELATED APPLICATION

This application claims priority under 35 U.S.C. § 119 to Indian Patent Application No. 202141051193, filed on Nov. 9, 2021, the entire contents of which are incorporated herein by reference

### FIELD OF THE DISCLOSURE

The present disclosure relates generally to the field of cloud computing. More particularly, the disclosure relates to methods and systems for regular hardware testing of servers on cloud space.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

With the rapid development of information technology, the application of computer hardware devices has become more and more popular. In a computer-related hardware device or system, a variety of tests are required to understand whether the hardware device or system is functioning properly under various conditions and how the system is performing.

A datacenter in cloud-computing, is a physical facility that organizations use to house their critical applications and data. A datacenter’s design is based on a network of computing and storage resources that enable the delivery of shared applications and data. The key components of a datacenter design include routers, switches, firewalls, storage systems, servers, and application-delivery controllers. Thus, in a cloud environment, hardware unreliability is a big challenge. Hardware can malfunction any time and that reduces the availability of servers in production. Further, hardware testing can’t be done on a machine as long as production services are using it. Conventionally, when a datacentre with a plurality of servers has a hardware failure in any of its servers, another server takes over the operation that is performed by the faulty server so as to prevent the service from being stopped. This is a reactive approach to a hardware or network failure that the systems follow. Whenever a server goes down, it is repaired & brought back to production.

In this, the users are either given an alternate server to which their resources are migrated, or they have to set up a new one from scratch. This method may cause downtime for the users. Repeated failures in a reactive approach decrease the lifetime of hardware and also incur unnecessary extra costs. Further, it also decreases the number of servers available for production use. Thus, there exists an imperative need in the art to provide a system and method for proactively identifying hardware issues and fixing them. This will help maximize the availability of servers for production.

### SUMMARY

This section is intended to introduce certain objects and aspects of the disclosed method and system in a simplified form and is not intended to identify the key advantages or features of the present disclosure.

One aspect of the present disclosure relates to a system for testing of datacenter hardware. Said system comprises a processing unit and a testing unit coupled to the processing unit. The processing unit is configured to identify one or more unused hardware servers from the datacenter hardware during a first target time period; and select, a first set of unused hardware servers for testing, from the identified one or more unused hardware servers based on one or more predefined rules. Further, the testing unit is configured to perform one or more tests on the selected first set of unused hardware servers, wherein each unused hardware server from the selected first set of unused hardware servers is in operational state.

Another aspect of the present disclosure relates to a method for testing of datacenter hardware comprising one or more hardware servers. Said method comprises: (1) identifying, by a processing unit, one or more unused hardware servers from the datacenter hardware during a first target time period, (2) selecting, by the processing unit, a first set of unused hardware servers for testing, from the identified one or more unused hardware servers based on one or more predefined rules, and (3) performing, by a testing unit, one or more tests on the selected first set of unused hardware servers, wherein each unused hardware server from the selected first set of unused hardware servers is in operational state.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1A illustrates an exemplary method flow diagram depicting a known or existing method for repairing of datacenter hardware in case or a hardware failure.

FIG. 1B illustrates an architecture of a system for a system for testing of datacenter hardware, in accordance with exemplary embodiments of the present disclosure.

FIG. 2 illustrates an exemplary method flow diagram depicting a method for testing of datacenter hardware, in accordance with exemplary embodiments of the present disclosure.

FIG. 3 illustrates an instance implementation of a method for testing of datacenter hardware, in accordance with exemplary embodiments of the present disclosure.

FIG. 4 illustrates an instant implementation of a method for testing of datacenter hardware across days, in accordance with exemplary embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processor” or “processing unit” includes processing unit, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or image processing unit is a hardware processor.

As used herein, “health” refers to health of a server which means how efficiently a server accomplishes an assigned task. A healthy server passes a set of benchmark tests. Thus, a healthy server is the one which is in operational state, has no hardware issues and is capable to run and serve production traffic. On the contrary, a server that does not pass the benchmark tests may have a higher likelihood of failure, that is, the failure of hardware components of the server and issues like latency, and inaccuracy, and thus may not be called a healthy server. This likelihood of failure may increase, or the server health may depreciate due to various reasons such as overclocking the processors, overloading memory disks, fluctuating or non-optimal power supplies, etc. Further, as used herein, “operational state” refers to a state of a server when it is at least able to perform tasks efficiently or inefficiently. The term operational state is used irrespective of usage of the server, in that, a server may said to be in operational state irrespective of whether it is in use or in production services or not.

In a known solution, a system for estimating a remaining life expectancy value for hardware components used in a computing system is provided. Upon detection of an abnormal event, the age or health of the components is identified. Various parameters are checked to determine the age or health of the hardware components. Upon detecting an age adjustment condition, the affected hardware components are identified. An age adjustment parameter is determined for the affected hardware components. Based on this, the adjusted age is stored for reference while taking actions such as component replacement and workload allocation.

However, a major drawback of this system is that the age or health of the components of the system components is assessed only when an abnormal event has already happened, and various components have been affected due to that event. This is similar to the reactive approach as discussed in the background section. The tests are not performed on regular basis, and also, they are not done on unused servers.

Hereinafter, exemplary embodiments of the present disclosure will be described in detail with reference to the accompanying drawings so that those skilled in the art can easily carry out the solution provided by the present disclosure.

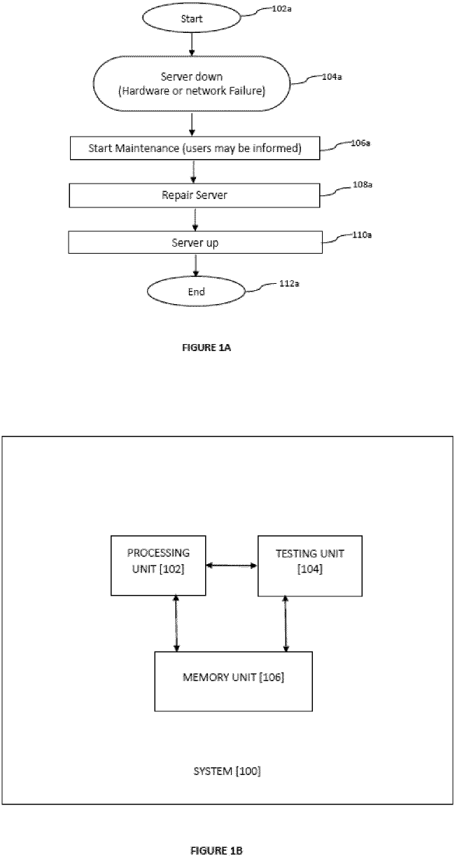

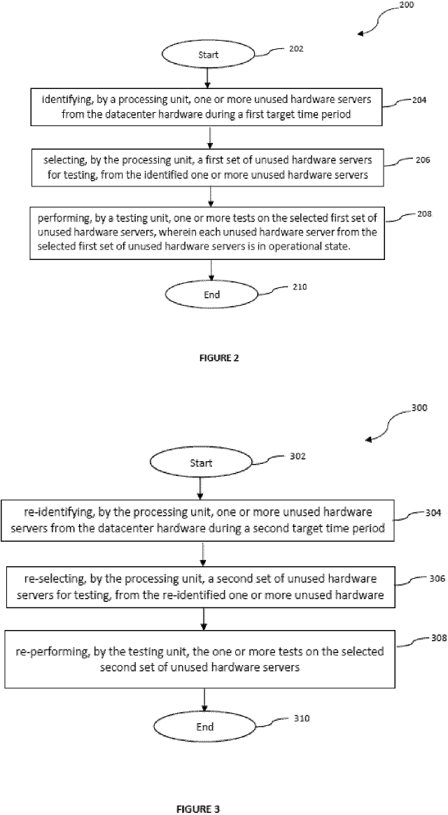

The approach that the existing systems follow is shown in FIG. 1A. In this approach (may be called as ‘reactive approach’ to a hardware or network failure), whenever a server goes down, it is repaired and brought back to production. As shown in FIG. 1A, the known method starts at step 102a and moves to step 104a. At step 104a, a server or network goes down. When the maintenance of the server is started at step 106a, the users are informed about the same as the servers cannot be repaired while in production. Thus, this method may cause downtime for the users. The users are either given an alternate server to which their resources are migrated, or they have to set up a new one from scratch. This may not only incur extra time as well as costs for setting up a new server but may also incur losses while the users are unable to access the unhealthy server. Further, the server is repaired at step 108a. After the server is repaired, it is provided to the users at step 110a. Thus, this known method ends at step 112a as shown.

However, most modem cloud managers (for example, Kubernetes) have the auto scale feature built into them. Auto-scaling is a way to automatically scale up or down the number of computing resources that are allocated to an application based on its needs at any given time. The traditional, dedicated hosting environments were limited by availability of hardware resources, and it was difficult to compute the requirements of servers, scaling requirements, for a website or application. Once those server resources were in full usage, the site could experience performance issues such as lags, delays or sluggish response, and could even possibly crash. This could cause loss of data and/or potential business. Autoscaling feature allows to set up and configure the necessary trigger points, so that one can create an automated setup that automatically reacts to various monitored conditions when thresholds are exceeded.

Thus, as the cloud manager scales down the resources in use, the servers not in use can be taken out of rotation for conducting hardware tests. The hardware tests will help identify issues related to disk, NIC, RAM, fan, motherboard, and other related issues. They can also help identify firmware and OS related issues and take necessary corrective actions automatically. The tests can mark machines as ‘unhealthy’, prompting necessary corrective actions whether automated or manual.

FIG. 1B illustrates an architecture of a system for a system for testing of datacenter hardware, in accordance with exemplary embodiments of the present disclosure. As shown, the system [100] comprises a processing unit [102], a testing unit [104] and a memory unit [106].

The processing unit [102] is configured to identify one or more unused hardware servers from the datacenter hardware during a first target time period. This first target time period may be determined by the processing unit based on user traffic on the datacenter hardware. For example, in a known case, the usual traffic on the datacenter may be low during night time and high during day time. In that case, the processing unit [102] may be configured to determine a number of servers to be tested. This may be a maximum number of servers to be tested, meaning that, if this determined number of servers to be tested is greater than the unused servers available, only the unused set of servers would be taken into consideration for further steps. However, if the determined number of servers to be tested is less than the unused servers available for testing, then the unused servers considered for testing may be subject to this maximum number of servers as determined by the processing unit. One skilled in the art may appreciate that this determination of maximum number of servers to be tested is only exemplary and may or may not be carried out by the processing unit.

Also, it is pertinent to note that all unused servers are not taken for testing at the same time. Further, the processing unit [102] selects a first set of unused hardware servers for testing, from the identified one or more unused hardware servers based on one or more predefined rules. In an implementation, the one or more predefined rules can be an order of testing associated with the one or more unused hardware servers. For example, the server which has been recently tested may be lower in priority to be tested than the server which has not been recently tested (at least relatively in comparison to another server). Thus, the server which has been least recently tested will be taken at priority for testing. Also, it may not be necessary that the server which is selected for testing is not functioning properly or has failed. Additionally, some servers may be kept unused as a precaution for any sudden or unforeseen increase in incoming traffic. In an implementation, the decision for the number of servers to be taken for testing may be based on a dynamic threshold.

The processing unit [102] is coupled with the testing unit [104] and provides the selected set of unused hardware servers for testing to the testing unit [104]. The testing unit [104] is configured to perform one or more tests on the selected first set of unused hardware servers. In this, each unused hardware server from the selected first set of unused hardware servers may be in an operational state. The operational state refers to the state that the server may be used as and when required and may be a very healthy server with a less likelihood of failure or may be a less healthy server which relatively higher likelihood of failure in the near future.

Further, the testing unit [104], by performing of one or more tests on the selected set of unused hardware servers, is further configured to determine a set of healthy hardware servers and a set of unhealthy hardware servers from the set of unused hardware servers that are tested. The set of healthy hardware servers as determined by the testing unit on the basis of a set of benchmark tests are the hardware servers that are fit for getting consumed in production, that is, they can be further provided to the users as and when required. Thus, the one or more healthy hardware servers from the set of healthy hardware servers, are further provided for production based on an order of testing associated with the one or more healthy hardware servers. This order of testing associated with the one or more healthy hardware servers may refer to how recently a server has been tested and decides the priority on which the servers will be provided for production. For example, a server that has been tested very recently may be provided higher in priority for production and a server that has not been recently tested (at least relatively as compared to another server), may be provided lower in priority for production.

Further, the memory unit [106] is operably coupled with the processing unit [102] and is configured to store the information processed by the processing unit [102] and to provide information required by the processing unit [102]. Additionally, the memory unit [106] may be operably coupled with the testing unit [104] to send and receive data from the testing unit [104]. This may include the information related to the number of servers that are to be tested by the testing unit [104] and during which target time period, the identification of servers as to which servers are to be tested by the testing unit [104], the data related to the testing of servers such as the time at which a particular server was tested, the data related to the health of servers, that is, the parameters determined for each of the servers, data related to the usage of servers, that is, which servers are in use or under production services and which servers are not in use or not under production services, or an account of time period of each server when it was in production. A person skilled in the art would appreciate that this information as noted above to be stored by the memory unit [106] is only exemplary and the memory unit [106] may store any other information that may be required by any component of the system [100].

Further, the system [100] is further configured to repeat the method to perform testing on a second set of unused hardware servers, a third set of unused hardware servers a fourth set of unused hardware servers, a fifth set of unused hardware servers, and so on, wherein the sets of unused hardware servers may comprise one or more different unused hardware servers. In that, the processing unit [102] is further configured to: re-identify, one or more unused hardware servers from the datacenter hardware during a second target time period, and re-select, a second set of unused hardware servers for testing, from the re-identified one or more unused hardware servers. Also, the testing unit [104] is further configured to perform one or more tests on the re-selected second set of unused hardware servers, wherein each unused hardware server from the selected second set of unused hardware servers is in operational state.

Referring to FIG. 2, an exemplary method flow diagram depicting a method for testing of datacenter hardware is shown. The method starts at step 202 and goes to step 204. At step 204, the processing unit [102] identifies one or more unused hardware servers from the datacenter hardware during a first target time period. This first target time period is determined based on user traffic on the datacenter hardware.

For example, in a known case, the usual traffic on the datacenter may be low during night time and high during day time. Thus, night time may be identified as the first target time period. In that case, the processing unit [102] may be configured to determine a number of servers to be tested. This may be a maximum number of servers to be tested, meaning that, if this determined number of servers to be tested is greater than the unused servers available, only the unused set of servers would be taken into consideration for further steps. However, if the determined number of servers to be tested is less than the unused servers, then the unused servers considered for testing would be subject to this maximum number of servers as determined by the processing unit. One skilled in the art may appreciate that this determination of maximum number of servers to be tested is only exemplary and may or may not be carried out by the processing unit.

Also, it is pertinent to note that all unused servers may not be taken for testing at the same time. Thus, in step 206, a first set of unused hardware servers is selected from the identified one or more unused hardware servers for testing based on one or more predefined rules. In an implementation, the one or more predefined rules can be an order of testing associated with the one or more unused hardware servers. For example, the server which has been recently tested may be lower in priority to be tested than the server which has not been recently tested (at least relatively in comparison to another server). Thus, the server which has not been recently tested will take at priority for testing. Also, it may not be necessary that the server which is selected for testing is not functioning properly or has failed.

In step 208, a testing unit [104] performs one or more tests on the selected first set of unused hardware servers. In this, each unused hardware server from the selected first set of unused hardware servers may be in an operational state. The operational state refers to the state that the server may be used as and when required and may be a very healthy server with a less likelihood of failure or may be a less healthy server which relatively higher likelihood of failure in the near future.

This performing of one or more tests by the testing unit [104] on the selected set of unused hardware servers further comprises determining a set of healthy hardware servers and a set of unhealthy hardware servers from the set of unused hardware servers. The set of healthy hardware servers as determined after the testing unit on the basis of a set of benchmark tests are the hardware servers that are fit for getting consumed in production, that is, they can be further provided to the users as and when required. Thus, the one or more healthy hardware servers from the set of healthy hardware servers, are further provided for production based on an order of testing associated with the one or more healthy hardware servers. This order of testing associated with the one or more healthy hardware servers may refer to how recently a server has been tested and decides the priority on which the servers will be provided for production. For example, a server that has been tested very recently may be provided higher in priority for production and a server that has not been recently tested (at least relatively as compared to another server), may be provided lower in lower in priority for production.

This process ends at step 210, however, the method steps may further be repeated to perform testing on a second set of unused hardware servers, a third set of unused hardware servers a fourth set of unused hardware servers, a fifth set of unused hardware servers, and so on, wherein the sets of unused hardware servers may comprise one or more different unused hardware servers. This repetition of steps includes: re-identifying , by the processing unit [102], one or more unused hardware servers from the datacenter hardware during a second target time period; re-selecting, by the processing unit [102], a second set of unused hardware servers for testing, from the re-identified one or more unused hardware servers; and re-performing, by the testing unit [104], the one or more tests on the selected second set of unused hardware servers, wherein each unused hardware server from the selected second set of unused hardware servers is in operational state.

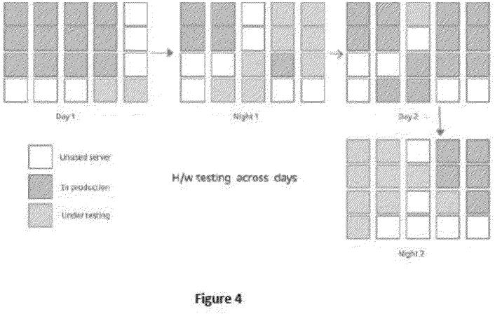

FIG. 3 illustrates an instance implementation of a method for testing of datacenter hardware, in accordance with exemplary embodiments of the present disclosure. As discussed above the method [200] steps may further be repeated to perform testing on a second set of unused hardware servers, a third set of unused hardware servers a fourth set of unused hardware servers, a fifth set of unused hardware servers, and so on, wherein the sets of unused hardware servers may comprise one or more different unused hardware servers. Thus, FIG. 3 shows this repetition of steps in an instance implementation. The method of repeating to perform testing on a second set of unused hardware servers starts at step 302 and goes on to step 304.

At step 304, the processing unit [102] re-identifies one or more unused hardware servers from the datacenter hardware. Next, in step 306, a second set of unused hardware servers is re-selected from the re-identified one or more unused hardware servers for testing. This selection of a second set of unused hardware servers for testing may be based on an order of testing associated with the one or more unused hardware servers. Further, in step 308, the testing unit [104] performs one or more tests on the selected second set of unused hardware servers. In this, each unused hardware server from the selected second set of unused hardware servers may be in an operational state. This performing of one or more tests by the testing unit [104] on the selected set of unused hardware servers further comprises determining a set of healthy hardware servers and a set of unhealthy hardware servers from the set of unused hardware servers. The set of healthy hardware servers as determined after the testing means the hardware servers are fit for getting consumed in production, that is, they can be further provided to the users as and when required. Thus, the one or more healthy hardware servers from the set of healthy hardware servers, are further provided for production based on an order of testing associated with the one or more healthy hardware servers. This order of testing associated with the one or more healthy hardware servers may refer to how recently a server has been tested and decides the priority on which the servers will be provided for production.

This process ends at step 310, however, the method steps may further be repeated to perform testing on a third set of unused hardware servers a fourth set of unused hardware servers, a fifth set of unused hardware servers, and so on, wherein the sets of unused hardware servers may comprise one or more different unused hardware servers.

As discussed, In the real world, in the present cloud environment, load or the user traffic usually cycles between day and night, and so do the number of servers available in production. For instance, at night, when the load is low, a cloud manager is likely to scale down its resources, thereby making servers available for conducting hardware tests. The present disclosure provides automated systems that help execute these tests intelligently. After the hardware tests are completed, the healthy servers may be released back to production before load rises again the next day. This may follow day after day, and each time, a new set of servers may be taken up for tests. The implementation of the present disclosure ensures that scaling up and down of resources would be smart and take into consideration whether a server has had hardware tests conducted on it recently and hence be less likely to be tested. This novel proactive approach helps maximize the availability of production servers. This improves the efficacy and reliability of those cloud-managers, at the same time increasing the lifetime of hardware.

FIG. 4 illustrates an instance implementation of a method for testing of datacenter hardware across days, in accordance with exemplary embodiments of the present disclosure. As shown, the FIG. 4 shows the various servers of a datacenter hardware, that is, servers under production, servers under testing, and unused servers. For instance, the datacenter experiences higher load in daytime and lower load in nighttime. Thus, as shown in the figure, a higher amount (12 in number) of servers are under production on Day 1, and 6 servers are unused that are not being tested and 2 unused servers are under testing. The 6 unused servers are not provided for testing in anticipation of requirement of servers for production in case there is a heavy load of user traffic that may occur suddenly at the datacentre. Further, in the Night 1, there are only 5 servers under production, 7 servers are unused and not being tested, and 8 unused servers are under testing. Further, the next day, i.e., in Day 2, 13 servers are under production, 6 servers are unused and not being tested, and 1 unused server is under testing. Further, in Night 2 as shown, there are 5 servers under production, 6 servers are unused and not being tested, and 9 unused servers are under testing. It is pertinent to note that each time, that is, Day 1, Night 1, Day 2 and Night 2, different set of servers are taken for testing. A person skilled in the art may appreciate that this is only an instance implementation provided for the ease of understanding and actual number of servers in a datacenter, sets of servers under production, sets of unused servers not being tested, and sets of servers taken under testing may vary as per requirement.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

We claim:

1. A method for testing of datacenter hardware comprising one or more hardware servers, the method comprising:
identifying, by a processing unit [102], one or more unused hardware servers from the datacenter hardware during a first target time period;
selecting, by the processing unit [102], a first set of unused hardware servers for testing, from the identified one or more unused hardware servers based on one or more predefined rules; and
performing, by a testing unit [104], one or more tests on the selected first set of unused hardware servers, wherein each unused hardware server from the selected first set of unused hardware servers is in operational state.

2. The method as claimed in claim 1, wherein the one or more tests are performed during the first target time period.

3. The method as claimed in claim 1, wherein the first target time period is determined based on user traffic on the datacenter hardware.

4. The method as claimed in claim 1, wherein selecting, by the processing unit [102], a first set of unused hardware servers for testing is based on an order of testing associated with the one or more unused hardware servers.

5. The method as claimed in claim 1, wherein performing, by a testing unit [104], one or more tests on the selected set of unused hardware servers further comprises determining by the testing unit a set of healthy hardware servers and a set of unhealthy hardware servers from the set of unused hardware servers.

6. The method as claimed in claim 5, wherein one or more healthy hardware servers from the set of healthy hardware servers, are further provided for production based on an order of testing associated with the one or more healthy hardware servers.

7. The method as claimed in claim 1, the method further comprises:
re-identifying, by the processing unit [102], one or more unused hardware servers from the datacenter hardware during a second target time period;
re-selecting, by the processing unit [102], a second set of unused hardware servers for testing, from the re-identified one or more unused hardware servers based on one or more predefined rules; and
re-performing, by the testing unit [104], the one or more tests on the selected second set of unused hardware servers, wherein each unused hardware server from the selected second set of unused hardware servers is in operational state.

8. The method as claimed in claim 7, wherein the second set of unused hardware servers comprises one or more unused hardware servers that are different than the first set of unused hardware servers.

9. A system [100] for testing of datacenter hardware comprising one or more hardware servers, the system comprising:
a processing unit [102], configured to:
identify, one or more unused hardware servers from the datacenter hardware, and
select, a first set of unused hardware servers for testing, from the identified one or more unused hardware servers based on one or more predefined rules; and
a testing unit [104] connected to the processing unit [102], the testing unit [104] being configured to perform one or more tests on the selected first set of unused hardware servers, wherein each unused hardware server from the selected first set of unused hardware servers is in operational state.

10. The system as claimed in claim 9, wherein the one or more tests are performed during a first target time period.

11. The system as claimed in claim 10, wherein the first target time period is determined based on user traffic on the datacenter hardware.

12. The system as claimed in claim 9, wherein selecting, by the processing unit [102], a first set of unused hardware servers for testing is based on an order of testing associated with the one or more unused hardware servers.

13. The system as claimed in claim 9, wherein performing, by a testing unit [104], one or more tests on the selected set of unused hardware servers further comprises determining by the testing unit a set of healthy hardware servers and a set of unhealthy hardware servers from the set of unused hardware servers.

14. The system as claimed in claim 13, wherein one or more healthy hardware servers from the set of healthy hardware servers, are further provided for production based on an order of testing associated with the one or more healthy hardware servers.

15. The system as claimed in claim 9, wherein
the processing unit [102] is further configured to:
re-identify, one or more unused hardware servers from the datacenter hardware during a second target time period, and
re-select, a second set of unused hardware servers for testing, from the re-identified one or more unused hardware servers based on one or more predefined rules; and
the testing unit [104] is further configured to perform one or more tests on the reselected second set of unused hardware servers, wherein each unused hardware server from the selected second set of unused hardware servers is in operational state.

16. The system as claimed in claim 15, wherein the second set of unused hardware servers comprises one or more unused hardware servers that are different than the first set of unused hardware servers.
